(19) United States
(12) Patent Application Publication
(10) Pub. No.: US 2026/0072200 A1
(43) Pub. Date: Mar. 12, 2026

(54) LENS ELEMENT AND ELECTRONIC DEVICE

(71) Applicant: Japan Display Inc., Tokyo (JP)

(72) Inventor: Junko NAGASAWA, Tokyo (JP)

(21) Appl. No.: 19/079,731

(22) Filed: Mar. 14, 2025

(30) Foreign Application Priority Data
Mar. 19, 2024 (JP) 2024-043752

(51) Int. Cl. G02B 1/14; G02B 1/11; G02B 5/30

(52) U.S. Cl. CPC G02B 1/14; G02B 1/11; G02B 5/30

(57) ABSTRACT

According to one embodiment, a lens element includes an underlying layer, a plurality of lenses disposed on the underlying layer, a lens protection layer covering each of the lenses and formed of a transparent inorganic material, and an overcoat layer covering the lens protection layer and having a refractive index lower than each of the lenses.

### CROSS-REFERENCE TO RELATED APPLICATIONS

This application is based upon and claims the benefit of priority from Japanese Patent Application No. 2024-043752, filed Mar. 19, 2024, the entire contents of which are incorporated herein by reference.

### FIELD

Embodiments described herein relate generally to a lens element and an electronic device.

### BACKGROUND

In recent years, there have been proposals for combining microlenses with various types of elements. One example of such a combination is a technique for combining microlenses with solid-state photoelectric conversion elements in order to improve the sensitivity of solid-state image sensors.

### BRIEF DESCRIPTION OF THE DRAWINGS

FIG. 1 is a plan view schematically showing a lens element 1 of an embodiment.

FIG. 2 is a diagram a cross-sectional view schematically showing the lens element 1 of the first embodiment taken along the line V-V in FIG. 1.

FIG. 3 is a diagram a cross-sectional view schematically showing a lens element 1 of the second embodiment taken along the line V-V in FIG. 1.

FIG. 4 is a diagram illustrating a method of manufacturing the lens element 1.

FIG. 5 is a diagram illustrating the method of manufacturing the lens element 1.

FIG. 6 is a cross-sectional view schematically showing an electronic device 2 of the third embodiment.

FIG. 7 is a cross-section view schematically showing an electronic device 2 of the fourth embodiment.

### DETAILED DESCRIPTION

In general, according to one embodiment, a lens element comprises an underlying layer, a plurality of lenses disposed on the underlying layer, a lens protective layer covering each of the plurality of lenses and formed of a transparent inorganic material, and an overcoat layer covering the lens protective layer and having a refractive index lower than that of each of the plurality of lenses.

According to another embodiment, an electronic device comprises the above-mentioned lens element, a substrate, and a light emitting element disposed between the lens element and the substrate.

According to still another embodiment, an electronic device comprises the above-mentioned lens element, a substrate, and an optical sensor disposed between the lens element and the substrate.

According to the above-described configuration, it is possible to provide a lens element and electronic device that can obtain a desired optical performance.

Embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Note that, in order to make the descriptions more easily understandable, some of the drawings illustrate an X axis, a Y axis and a Z axis orthogonal to each other. A direction along the X axis is referred to as a first direction X, a direction along the Y axis is referred to as a second direction Y and direction along the Z axis is referred to as a third direction Z. Further, viewing various elements in parallel with the third direction Z is referred to as plan view.

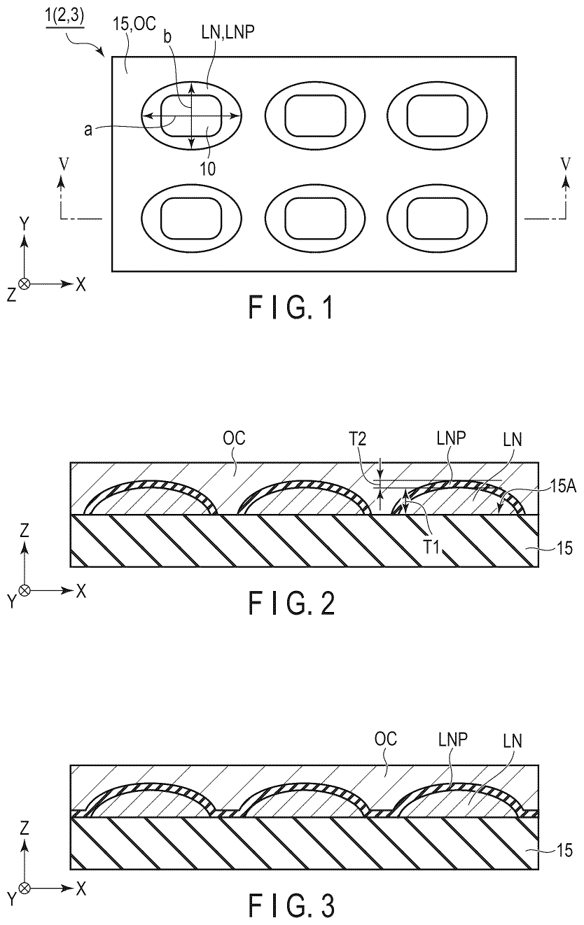

FIG. 1 is a plan view schematically showing a lens element 1 according to an embodiment.

The lens element 1 comprises an underlying layer 15, a plurality of lenses LN, a lens protective layer LNP, and an overcoat layer OC.

In this embodiment, the shape of the underlying layer 15 in plan view is not limited to a rectangle, but may as well be any other shape, such as a square or other polygon, circle, or ellipse.

The underlying layer 15 is a transparent organic insulating layer, and is formed using a resin material such as acrylic resin, epoxy resin, or polyimide resin. Note that the underlying layer 15 may as well be a transparent inorganic insulating layer, glass substrate, resin substrate or the like.

The plurality of lenses LN are arranged at a predetermined interval along the first direction X and the second direction Y. Each of the lenses LN is disposed so as to overlap respectively the various elements 10, which will be described later. For example, the layout of the lenses LN is set in correspondence with the layout of the elements 10. The pitch of each adjacent pair of the lenses LN is equivalent to the pitch of each adjacent pair of the elements 10.

In the example shown in the figure, the lenses LN each have an elliptical shape in which a width an along the first direction X is longer than a width b along the second direction Y in plan view. The shape of the lenses LN is not limited to that of the example shown in the figure, and may as well be an elliptical shape in which the width a is shorter than the width b, or may as well be a circular shape in which the width a and width b are the same as each other. The shape of the lenses LN may as well be changed as appropriate in accordance with the shape of the overlapping element 10.

The lenses LN can be formed, for example, using various transparent resin materials, such as acrylic resin. From the perspective of suppressing undesired reflection and refraction at the interface between the underlying layer 15 and the lenses LN, it is desirable that the lenses LN should be formed using a material with a refractive index equivalent to that of the underlying layer 15. The underlying layer 15 can be formed using the same material as that of the lens LN, in which case the underlying layer 15 and the lens LN may be formed to be integrated with each other as one body.

The lenses LN are covered by the lens protective layer LNP, and the lens protective layer LNP is covered by an overcoat layer OC. The lens protective layer LNP and the overcoat layer OC will be explained in detail with reference to FIG. 2.

The elements 10 are covered by the underlying layer 15. The elements 10 are, for example, light emitting elements LD, optical sensors PD and the like. By combining each lens element 1 and each respective light emitting element LD, which is an example of the elements 10, an electronic device 2 can be configured. Further, by combining each lens element 1 and each respective optical sensor PD, which is an example of the elements 10, an electronic device 3 can be configured. Details thereof will be described later.

### First Embodiment

FIG. 2 is a cross-sectional view schematically showing lens elements 1 of the first embodiment taken along the line V-V in FIG. 1.

The plurality of lenses LN are arranged on the underlying layer 15 and are arranged at intervals along the first direction X. Each of the lenses LN is a convex lens. In the example illustrated, the lenses LN are aspherical lenses, but they may as well be spherical lenses or cylindrical lenses.

A thickness T1 of the lenses LN is not particularly limited. Here, the thickness T1 corresponds to the length along the third direction Z from an upper surface 15A of the underlying layer 15 (or the interface between the underlying layer 15 and the lens LN) to an apex of the lens LN.

The lens protective layer LNP covers each of the lenses LN. In the example shown in FIG. 2, the lens protective layer LNP covers these lenses LN each individually, and exposes the upper surface 15A of the underlying layer 15 between each adjacent pair of the lenses LN.

The lens protective layer LNP is formed of a transparent inorganic material. For example, the lens protective layer LNP is formed of silicon nitride as a transparent inorganic material.

The lens protective layer LNP is formed to have a substantially uniform thickness. At the apex of each lens LN, a thickness T2 of the lens protective layer LNP is less than the thickness T1 of the lens LN, for example, 300 nm or less.

The overcoat layer OC overlaps the lenses LN and covers the lens protective layer LNP. In the example shown in FIG. 2, the overcoat layer OC covers the underlying layer 15 between each adjacent pair of the lenses LN. Further, the overcoat layer OC functions as a planarization film that planarizes unevenness caused by multiple lenses LN and the lens protective layer LNP.

The overcoat layer OC is a transparent organic insulating layer formed from a material having a refractive index lower than that of the lenses LN.

For example, the overcoat layer OC can be formed using a resin material such as acrylic resin, epoxy resin, polyimide resin or the like.

Incidentally, the lenses LN are formed using a photosensitive resin material. As to this material, in the case where the cross-linking property of the resin material is low, if the resin material for forming the overcoat layer OC is directly applied onto the lenses LN while forming them, the resin material that constitutes the lenses LN may dissolve into the resin material that forms the overcoat layer OC. If the resin material that constitutes the lenses LN dissolves, the lenses LN may not be formed into the desired shape, and there is a possibility that the optical performance deteriorates due to changes in the refractive index and the generation of haze.

As a solution to the above-described drawback, in this embodiment, each of the lenses LN is covered with a lens protective layer LNP formed of a transparent inorganic material (silicon nitride). In other words, a lens protective layer LNP is interposed between each of the lenses LN and the overcoat layer OC. With this configuration, the overcoat layer OC is never brought into direct contact with the lenses LN. Therefore, the resin material used to form the overcoat layer OC is not brought into contact with the lenses LN, and the dissolution of the lenses LN can be suppressed. That is, it is possible to suppress the deformation of the lenses LN before and after the process of forming the overcoat layer OC. As a result, changes in the refractive index and the generation of haze can be suppressed, and the desired optical performance can be obtained.

Note here that silicon nitride, in particular, has a dense and uniform structure, and it has high chemical stability as well. For this reason, silicon nitride is suitable as a material for forming the lens protective layer LNP.

The thickness T2 of the lens protective layer LNP should preferably be as thin as possible, for example 50 nm or more, as long as the dissolution of the lenses LN is sufficiently suppressed when forming the overcoat layer OC. Further, when the thickness T2 of the lens protective layer LNP exceeds 300 nm, there is a risk of a decrease in yield or a lowering of optical characteristics. For this reason, it is preferable that the thickness of the lens protective layer LNP should be 50 nm or more and 300 nm or less.

In one example, the underlying layer 15, the lenses LN, and the lens protective layer LNP all have refractive indices substantially equal to each other. The overcoat layer OC has a refractive index lower than those of the underlying layer 15, lenses LN, and lens protective layer LNP.

As will be described later, the lens element 1 may as well comprise an optical film 16 on the overcoat layer OC. As the optical film 16, for example, a polarizer can be used.

### Second Embodiment

FIG. 3 is a cross-sectional view schematically showing a lens element 1 according to the second embodiment taken along the line V-V in FIG. 1.

The lens element 1 shown in FIG. 3 is different from the lens element 1 shown in FIG. 2 in that the lens protective layer LNP covers the underlying layer 15 between each respective pair of the lenses LN. The overcoat layer OC is apart from the underlying layer 15 between each adjacent pair of the lenses LN. The other components of the configuration are similar to those of the lens element 1 shown in FIG. 2, and therefore the explanations therefor will be omitted here.

With the second embodiment shown in FIG. 3 as well, advantageous effects similar to those of the first embodiment shown in FIG. 2 can be obtained. In addition, the process of individually patterning the lens protective layer LNP is not required, thereby making it possible to simplify the manufacturing process.

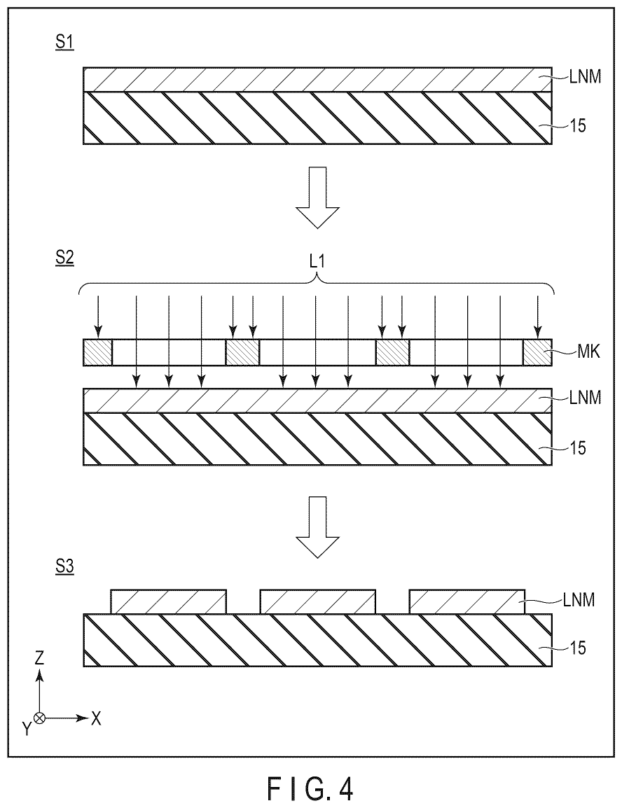

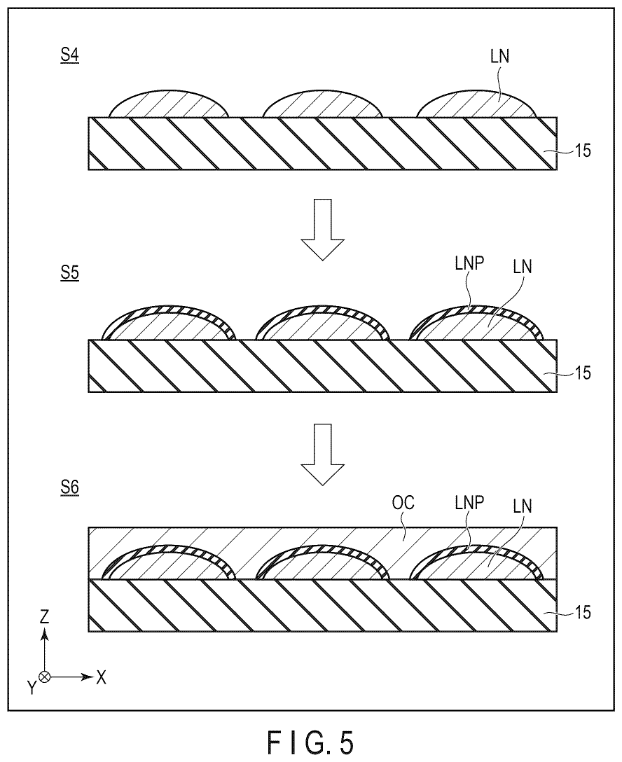

Next, a method of manufacturing the lens element 1 will be explained with reference to FIGS. 4 and 5.

First, as shown in the upper part of FIG. 4, a lens material LNM for forming the lenses LN is applied on the underlying layer 15 (the first step S1). The lens material LNM is, for example, a negative-type resin material.

After the first step (S1), as shown in the middle part of FIG. 4, a mask MK having apertures of a predetermined shape is placed on the lens material LNM. Then, light (for example, ultraviolet light) L1 is irradiated through the mask MK to expose the lens material LNM (second step S2).

Following the second step S2, as shown in the lower part of FIG. 4, the lens material LNM is developed (third step S3). In the example shown in the figure, the regions of the lens material LNM, which have been exposed to the light L1 remain, and the regions shielded by the mask MK are removed.

Subsequently, as shown in the upper part of FIG. 5, the remaining lens material LNM is baked, and convex lenses LNM are formed by reflow of the lens material LNM (fourth step S4) .

After the fourth step S4, a lens protective layer LNP is formed as shown in the middle part of FIG. 5 (fifth step S5). The lens protective layer LNP is formed by depositing silicon nitride using, for example, chemical vapor deposition (CVD). The lens protective layer LNP thus formed uniformly covers the underlying layer 15 and the lenses LN. In the example shown in the figure, the lens protective layer LNP is patterned after it is formed. In this manner, the lens protective layer LNP cover each lens LN individually, and exposes the underlying layer 15 between each adjacent pair of the lenses LN. Note that the patterning of the lens protective layer LNP may be omitted.

Following the fifth step S5, an overcoat layer OC is formed (sixth step S6) as shown in the lower part of FIG. 5. The overcoat layer OC is formed by applying a resin material to the lens protective layer LNP and then hardening the resin material. At this time, the lenses LN are covered by the lens protective layer LNP, and therefore the lenses LN are not brought into contact with the resin material used to form the overcoat layer OC. Thus, the lenses LN having the desired shape can be formed, and the lens element 1 with the desired optical performance can be manufactured.

Next, an electronic device to which the above-described lens element 1 is applied will be explained.

### Third Embodiment

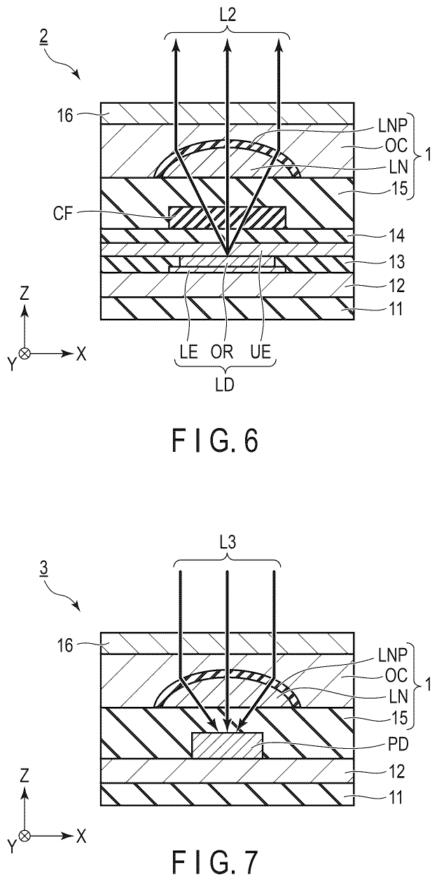

FIG. 6 is a cross-sectional view schematically showing an electronic device 2 according to the third embodiment.

The electronic device 2 comprises a substrate 11, a circuit layer 12, a partition 13, a light emitting element LD, a sealing layer 14, a color filter CF, a lens element 1, and an optical film 16.

The substrate 11 may be glass or a flexible resin film.

The circuit layer 12 is disposed on the substrate 11. The circuit layer 12 includes, for example, various circuits such as pixel circuits, various wiring lines such as scanning lines, signal lines, and power supply lines, and various insulating layers.

The light emitting element LD is, for example, an organic EL element, and includes a lower electrode LE, an organic layer OR, and an upper electrode UE. Further, the light emitting element LD is not limited to an organic EL element, and may as well be some other light emitting element such as a micro-LED or mini-LED.

The lower electrode LE is disposed on the circuit layer 12 and is electrically connected to a pixel circuit not shown in the figure. The lower electrode LE has, for example, a multilayer body that includes a transparent layer formed of an oxide conductive material such as indium tin oxide (ITO), and a reflective layer formed of a metal material such as silver.

The organic layer OR is disposed on the lower electrode LE. The organic layer OR includes an emission layer and further, various functional layers such as a hole injection layer, a hole transport layer, an electron blocking layer, a hole blocking layer, an electron transport layer, an electron injection layer and the like.

The partition 13 is formed to surround the lower electrode LE and the organic layer OR. The partition 13 can be formed from an inorganic insulating material or organic insulating material.

The upper electrode UE is disposed on the organic layer OR and the partition 13. The upper electrode UE is electrically connected to a power supply line not shown in the figure, and is set to a common potential, for example. The upper electrode UE is formed of a metal material, for example, an alloy of magnesium and silver (MgAg).

The sealing layer 14 is disposed to cover the upper electrode UE. The sealing layer 14 is formed as an inorganic insulating layer, such as silicon nitride (SiNx), silicon oxide (SiOx), or silicon oxynitride (SiON). Note that the sealing layer 14 may as well include an organic insulating layer in addition to the inorganic insulating layer.

The color filter CF is located directly above the light emitting element LD in the third direction Z, and is disposed on the sealing layer 14. Note that the color filter CF may as well be omitted.

The lens element 1 described above is formed on the color filter CF. In other words, the light emitting element LD is arranged between the substrate 11 and the lens element 1, and the color filter CF is arranged between the light-emitting element LD and the lens element 1. In the example shown in the figure, the underlying layer 15 of the lens element 1 covers the color filter CF. The lens LN is disposed directly above the light emitting element LD and the color filter CF.

The optical film 16 is disposed on the overcoat layer OC of the lens element 1. For the optical film 16, for example, a polarizer can be used. Note that the optical film 16 may be omitted.

According to the third embodiment with such a configuration, with the combination of the lens element 1 and the light emitting element LD, the internal reflection of light L2 emitted from the light emitting element LD in the electronic device 2 is suppressed, and the light L2 that has reached the underlying layer 15 is extracted by the lens LN and it contributes to display. Therefore, the efficiency of extraction of the light L2 can be improved, power saving can be achieved, and the brightness of the front surface can be improved.

### Fourth Embodiment

FIG. 7 is a cross-sectional view schematically showing an electronic device 3 according to the fourth embodiment taken along the line V-V in FIG. 1.

The electronic device 3 comprises a substrate 11, a circuit layer 12, an optical sensor PD, a lens element 1, and an optical film 16. Note that the optical film 16 may be omitted.

The circuit layer 12 is disposed on the substrate 11.

The optical sensor PD is disposed on the circuit layer 12. The optical sensor PD has a function of detecting light L3 entering from the upper surface of the electronic device 3 and emitting an electrical signal corresponding to the light intensity. For the optical sensor PD, for example, an organic photodiode or an inorganic photodiode can be used.

On the optical sensor PD, the lens element 1 described above is formed. In other words, the optical sensor PD is arranged between the substrate 11 and the lens element 1. In the example shown in the figure, the underlying layer 15 of the lens element 1 covers the optical sensor PD. The lens LN is disposed directly above the optical sensor PD.

In this embodiment, with a combination of the optical sensor PD and the lens element 1, it is possible to improve the light-focusing properties of the light L3 that enters from the upper surface, thereby making it possible to downsize the optical sensor PD.

As explained above, according to the embodiments, it is possible to provide a lens element and electronic device that can achieve the desired optical performance.

Based on the lens elements and electronic devices which have been described in the above-described embodiments, a person having ordinary skill in the art may achieve a lens element or an electronic device with an arbitral design change; however, as long as they fall within the scope and spirit of the present invention, such a lens element or an electronic device is encompassed by the scope of the present invention.

A skilled person would conceive various changes and modifications of the present invention within the scope of the technical concept of the invention, and naturally, such changes and modifications are encompassed by the scope of the present invention. For example, if a skilled person adds/deletes/alters a structural element or design to/from/in the above-described embodiments, or adds/deletes/alters a step or a condition to/from/in the above-described embodiment, as long as they fall within the scope and spirit of the present invention, such addition, deletion, and altercation are encompassed by the scope of the present invention.

Furthermore, regarding the present embodiments, any advantage and effect those will be obvious from the description of the specification or arbitrarily conceived by a skilled person are naturally considered achievable by the present invention.

What is claimed is

1. A lens element comprising:
an underlying layer;
a plurality of lenses disposed on the underlying layer;
a lens protective layer covering each of the plurality of lenses and formed of a transparent inorganic material; and
an overcoat layer covering the lens protective layer and having a refractive index lower than that of each of the plurality of lenses.

2. The lens element of claim 1, wherein
the overcoat layer has a refractive index lower than that of the lens protective layer.

3. The lens element of claim 1, wherein
the inorganic material is silicon nitride.

4. The lens element of claim 1, wherein
the underlying layer is a transparent organic insulating layer, and
the overcoat layer has a refractive index lower than that of the underlying layer.

5. The lens element of claim 1, wherein
the lens protective layer covers the underlying layer between the plurality of lenses.

6. The lens element of claim 1, wherein
the overcoat layer covers the underlying layer between the plurality of lenses.

7. The lens element of claim 1, wherein
the lens protective layer has a thickness less than that of each of the plurality of lenses.

8. The lens element of claim 1, wherein
the lens protective layer has a thickness of 50 nm or more and 300 nm or less.

9. The lens element of claim 1, wherein
the underlying layer and the plurality of lenses have refractive indices equal to each other.

10. The lens element of claim 1, wherein
the underlying layer and the plurality of lenses are formed of the same material.

11. The lens element of claim 1, wherein
the plurality of lenses and the lens protective layer have refractive indices equal to each other.

12. An electronic device comprising:
a lens element of claim 1; a substrate; and an light emitting element disposed between the lens element and the substrate.

13. The electronic device of claim 12, further comprising:
a color filter disposed between the lens element and the light emitting element.

14. The electronic device of claim 13, wherein
the underlying layer covers the color filter.

15. The electronic device of claim 12, further comprising:
an optical film on the overcoat layer.

16. The electronic device of claim 15, wherein
the optical film is a polarizer.

17. An electronic device comprising:
a lens element of claim 1, a substrate, and an optical sensor disposed between the lens element and the substrate.

18. The electronic device of claim 17, wherein
the underlying layer covers the optical sensor.

19. The electronic device of claim 17, further comprising:
an optical film on the overcoat layer.

20. The electronic device of claim 19, wherein
the optical film is a polarizer.
